(19) United States
(12) Patent Application Publication
(10) Pub. No.: US 2002/0150105 A1
(43) Pub. Date: Oct. 17, 2002

(54) Sequential feedback HEC checking method and circuit for asynchronous transfer mode (ATM)

(76) Inventors: Pei-Chieh Hsiao, TaiChung (TW); Hsin-Min Wang, KaoHsiung (TW); Huan-Tang Hsieh, Hsinchu (TW)

Correspondence Address: Raymond Sun, 12420 Woodhall Way, Tustin, CA, 92782, US

(21) Appl. No.: 10/120,732

(22) Filed: Apr. 11, 2002

(30) Foreign Application Priority Data
Apr. 12, 2001 (TW) 90108734

(51) Int. Cl. H04L 12/28; H04L 12/56

(52) U.S. Cl. 370/395.1; 714/746

(57) ABSTRACT

The present invention provides sequential feedback Header Error Correction (HEC) checking method and circuit for Asynchronous Transfer Mode (ATM). With design of hardware circuit, the present invention of sequential feedback Header Error Correction (HEC) checking method and circuit will allocate the cell boundary in ATM communication, and meanwhile control the state switching among three operation for cell delineation logic, i.e., HUNT, PRESYNC and SYNC.

### BACKGROUND OF THE INVENTION

(a). Field of the Invention

The present invention relates to Header Error Correction (HEC) checking method and circuit for asynchronous transfer mode (ATM). Especially, the present invention relates to sequential feedback Header Error Correction (HEC) checking method and circuit for Asynchronous Transfer Mode.

(b). Description of the Prior Arts

Asynchronous Transfer Mode (ATM) protocol is high-performance, cell-oriented switching and multiplexing technology that utilizes fixed-length packets to carry different types of information.

In Asynchronous Transfer Mode (ATM), all information is formatted into 53 bytes fixed-length cells that including 48 bytes payload data and 5 bytes cell header data and the cell is the basic unit in ATM data transfer. The header is organized for efficient switching in high-speed hardware implementations and carries payload-type information, virtual-circuit identifiers, and head error check.

In ATM network, the receiving end has to determine the beginning of a cell; therefore, the data in the header of a cell is used to detect the beginning of a cell. In practices, every bit that received by the receiving end will be calculated with a mathematical formula, that is, every time the receiving end receiving a bit, the bit has to be added with the bits received prior and perform the calculation to determine the beginning of a cell. In the case, the allocation of the beginning of a cell will cause much time. More over, the allocation of the begin of a cell not only happened in the beginning of the data transfer, even when the receiving end and the sending end are in the state of synchronization, the checking still going continuously to see if the beginning of a cell that found before is still valid. In ATM communication, such checking is indispensable and is always undergoing.

### SUMMARY OF THE INVENTION

The primary aspect of the present invention is to provide a sequential feedback Header Error Correction (HEC) checking method for Asynchronous Transfer Mode (ATM). Within, when ATM is in the HUNT state; which also known as the beginning of ATM communication, the offset register and the HEC register will be set to 0 and the data in the packet will be shifted to the buffer register bit by bit. Then, the data in the buffer register will be executed XOR calculation with the binary number 01010101 and come out with the first result, and the data will be shifted from the buffer register to the HEC register and offset register sequentially. After that, the first result and the HEC register execute XOR calculation, and the result is zero, the content of the logic circuit that used to store the HEC checking result will be changed, that is, the state of ATM switches to PRESYNC state. When ATM is in the PRESYNC or SYNC state in which the packet bit number is set to the default value of begin, the content of the offset register and the HEC register will be set to zero, then, the data in the packet will be shifted to the buffer register sequentially, and the value of the packet bit number changes every time the bit of the data shifted. After that, the data will be shifted sequentially to the HEC register and the offset register bit to bit. And when the value of packet bit number equals the default value of close, the data in the buffer register will be executed XOR calculation with the binary number 01010101, further, the result will be executed XOR with the data in the HEC register and come out with a new result that used as a reference to change the content stored in the logic circuit of HEC checking result.

The second aspect of the present invention is to provide a sequential feedback Header Error Correction (HEC) checking circuit for Asynchronous Transfer Mode (ATM). The sequential feedback Header Error Correction (HEC) checking circuit is comprising a buffer register, a offset register, a few XOR logic circuits (the first XOR logic circuit to the third logic circuit) and a HEC register. The HEC register is comprising the first bit store device to the eighth bit store device and four internal XOR logic circuit. The offset register is connecting to the output end of the buffer register and will output the bits that input from the buffer register. One end of the first XOR logic circuit is connecting to the output end of the buffer register just like the offset register.

In the HEC register, the first bit store device will receive the data output from the first XOR logic circuit. The first internal XOR logic circuit will receive the data output from the first bit store device, the first XOR logic circuit and the offset register. The second bit store device will receive the data output from the first internal XOR logic circuit. The second internal XOR logic circuit will receive the data output from the second bit store device and the first XOR logic circuit. The third bit store device will receive the data output from the second internal XOR logic circuit. The fourth bit store device will receive the data output from the third bit store device. The fifth bit store device will receive the data output from the fourth bit store device. The third internal XOR logic circuit will receive the data output from the fifth bit store device and the offset register. The sixth bit store device will receive the data output from the third internal XOR logic circuit. The fourth internal XOR logic circuit will receive the data output from the sixth bit store device and the offset register. The seventh bit store will receive the data output from the fourth internal XOR logic circuit. The eighth bit store device will receive the data output from the seventh bit store device and output the data to the first XOR logic circuit.

Outside the HEC register, the second XOR logic circuit will receive the data stored in the buffer register, execute XOR calculation with the binary data 01010101 and come out with a first result. The first result will be executed XOR calculation with the data stored in the HEC register by the third XOR logic circuit and a second result will be output to a control circuit. The control circuit controls the change of state in the receiving end of ATM according to the second result. As a result, the present invention will save much time that used for calculation every time the new bit coming from the network.

The appended drawings will provide further illustration of the present invention, together with the description, serve to explain the principles of the invention.

### BRIEF DESCRIPTION OF THE DRAWINGS

FIG. 1 shows the diagram of the switching among three states in ATM communication protocol.

FIG. 2 shows the partial flow chart of a preferred embodiment of the present invention.

FIG. 3A and FIG. 3B show the partial flow chart of the preferred embodiment showing in the FIG. 2.

FIG. 4A and FIG. 4B show the partial flow chart of the preferred embodiment showing in the FIG. 2.

FIG. 5 shows the diagram of the circuit of a preferred embodiment.

### DETAILED DESCRIPTION OF THE PRESENT INVENTION

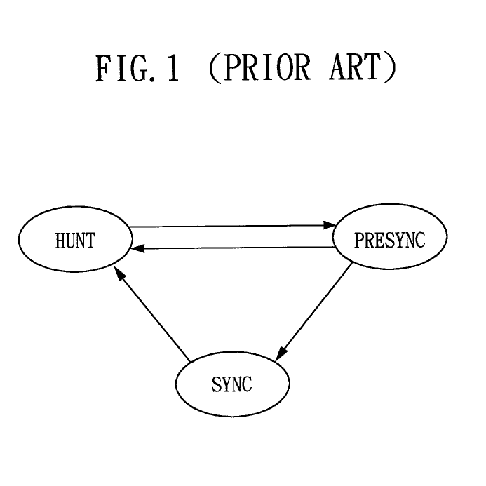

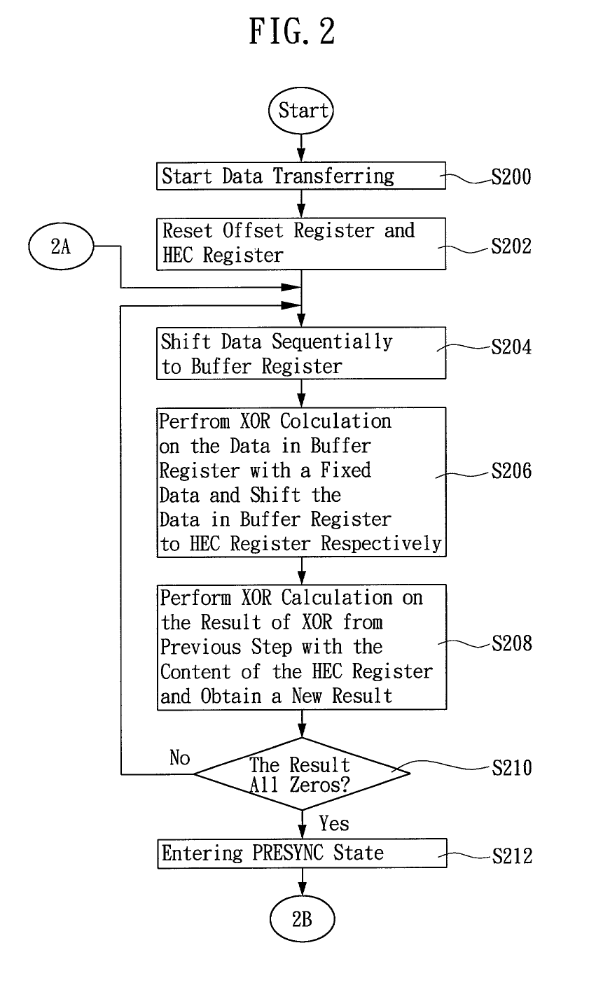

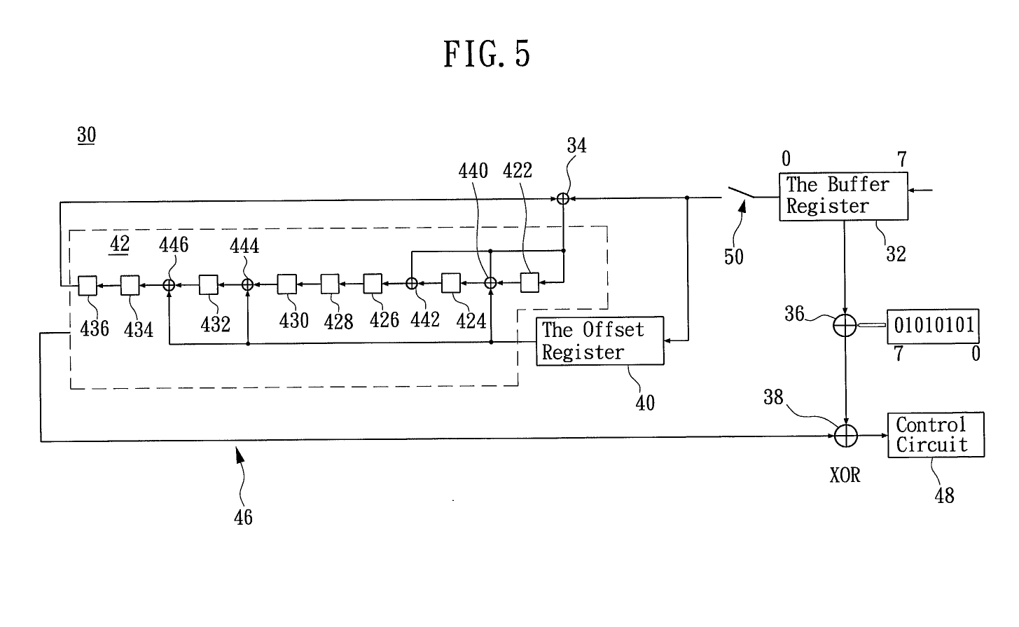

In order to illustrate the present invention more comprehensibly, the switching among three states in Asynchronous Transfer Mode will be introduced first. Please refer to FIG. 1, which is the diagram of the switching among three states in ATM communication protocol. In the beginning of the communication, the receiving end of ATM is in the HUNT state. When the cell boundary being allocated, the receiving end will switch to PRESYNC state. In the PRESYNC state, if the cell boundary allocated prior is not correct, the state will switch back to HUNT. Such testing and checking will continue for a few times until the proper cell boundary is allocated. When the cell boundary is allocated successfully, the state of the receiving end will switch from PRESYNC to SYNC. In the SYNC state, the receiving end will continuously check the cell boundary to make sure it is correct. If the errors happened too many times and exceed a certain value, the state will switch back to HUNT to reallocate the cell boundary. Please refer to the FIG. 2 which is the partial flow chart of a preferred embodiment of the present invention. Please also refer to the FIG. 5 concurrently; which is the diagram of the circuit of a preferred embodiment, to obtain better understanding. In the preferred embodiment, the data of ATM in the step S200 begins to transfer. The receiving end is in the state of HUNT as shown in FIG. 1. In the step S202; before the receiving end receives any data, the internal offset register 40 and the HEC register 42 will be reset. Then, the data will be transferred to receiving end, and in the step S204, the receiving end will shift the data sequentially to the buffer register 32. Next, the data in the buffer register 32 will be XORed with a fix binary value 01010101 as shown in FIG. 5 by the XOR logic circuit 36. In the step S206, one bit of the data in the buffer register 32 will be shifted to the HEC register 42 and the offset register 40. In the step S208, the result of XOR logic execution of S206 will be XORed with the 8 bits data read from the HEC register 42 by the XOR logic circuit 38. In the step S208, if all the bits of the results executed by the XOR logic are zero, the cell boundary will be allocated, and the process will be proceeding to step S212 that the state of receiving end will be switched to PRESYNC. However, if the results of all the bits executed by the XOR logic are not all zero; which means the proper cell boundary has not been allocated, the process will be going back to step S204 to continuously check the bit incoming next.

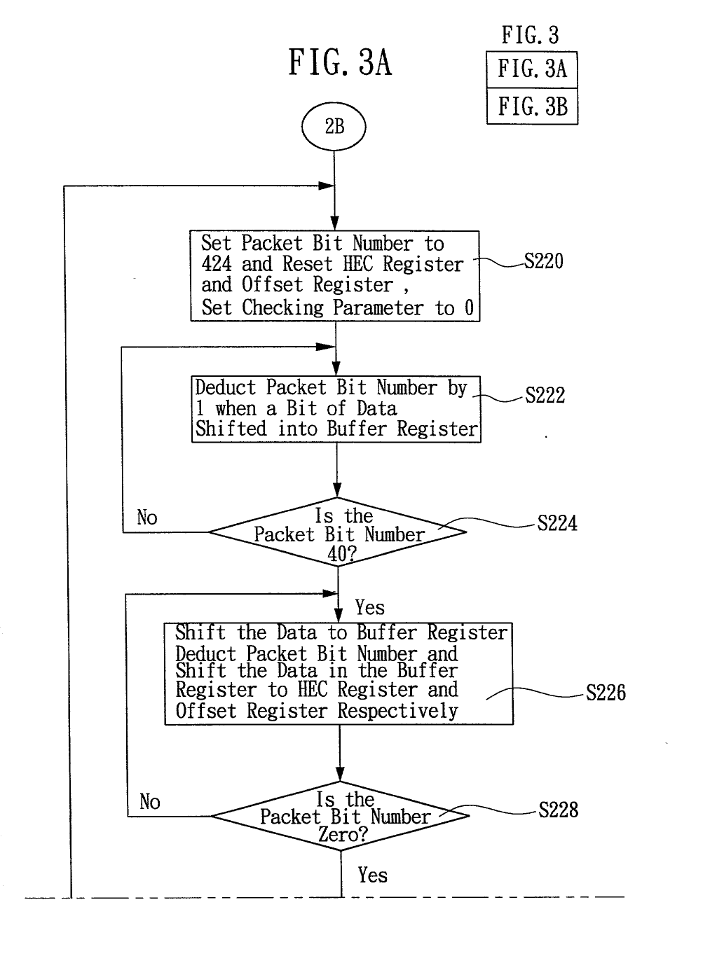

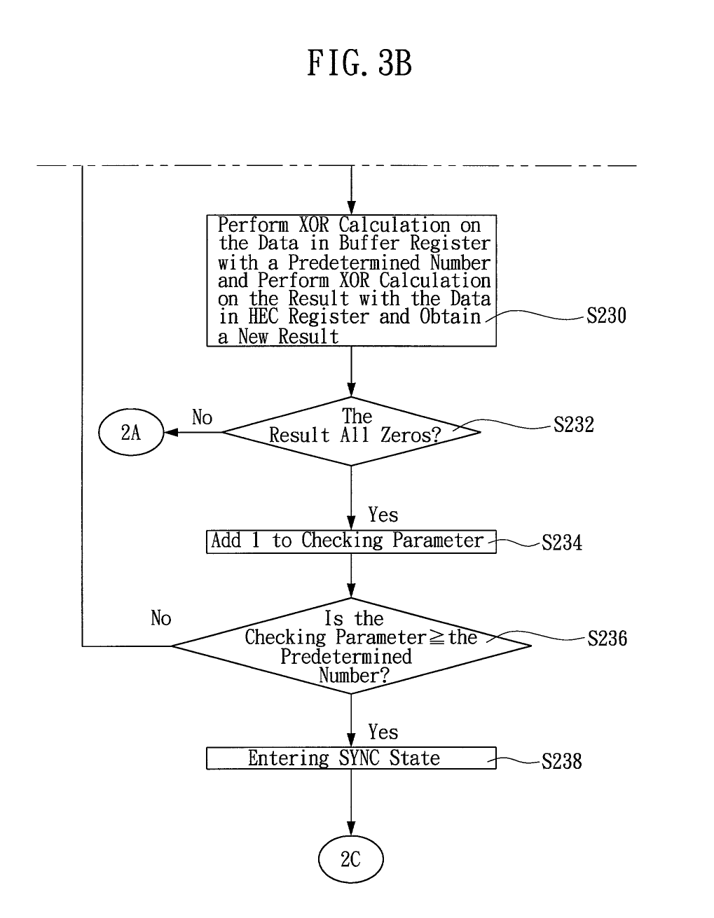

When the state of the receiving end switching from HUNT to PRESYNC, the process will step into another phase. Please refer to FIG. 3A and FIG. 3B together, which are the partial flow chart of the preferred embodiment showing in the FIG. 2. Please also refer to FIG. 5 concurrently to obtain better understanding. When the receiving end of ATM is in PRESYNC state, in step S220, a packet bit number that used to count the number of the receiving bit will be set to 424; the HEC register 42, the offset register 40 and a checking parameter will be reset. As described above, the data transferred in ATM is 53 bytes fixed-length, which is 424 bits. So, in this embodiment, the packet bit number is set to 424 for testing the cell boundary. After the packet bit number, the HEC register 42 and the offset register 40 being reset. In the step S222, the data will be shifted to buffer register 32 sequentially, and every time a bit being shifted to the buffer register 32, the number in the packet bit number will be deducted by one. In the step S224, the number in the packet bit number will be checked if equal to 40. If the number is not equal to 40, the process will be back to step S222 to continue transferring data and deducting number from the bit number packet, when the number is equal to 40, the process will proceed to step S226.

In step S226, the data transferred to ATM will be shifted to buffer register 32 continuously and the number in the packet bit number will keep on deducting. In the same time, the data in the buffer register 32 will be shifted to the HEC register 42 and the offset register 40 respectively. Before the number in the packet bit number reaching to zero, the process will keep repeating step S226 to transfer the data to its proper position; when the number in the packet bit number reaching to zero, the process will enter into step S230 to XOR the data in the buffer register 32 with the binary number 01010101 and come out with a first result, the first result will be XORed with the data stored in the HEC register 42 and come out with a second result, if the bits of the second result are not all zeros, the ATM receiving end will be switched back to the state of HUNT in the step S204 in FIG. 2 to allocate the cell boundary, and if the bits of the second result are all zeros, the checking parameter in step S234 will be added by one. Then, in step S236, the checking parameter will be checked if greater or equal to a predetermined number in order to determine if the receiving end of ATM needs back to step S220 to continuously check next incoming packet or to proceed to step S238 in which the receiving end of ATM is switched to SYNC state.

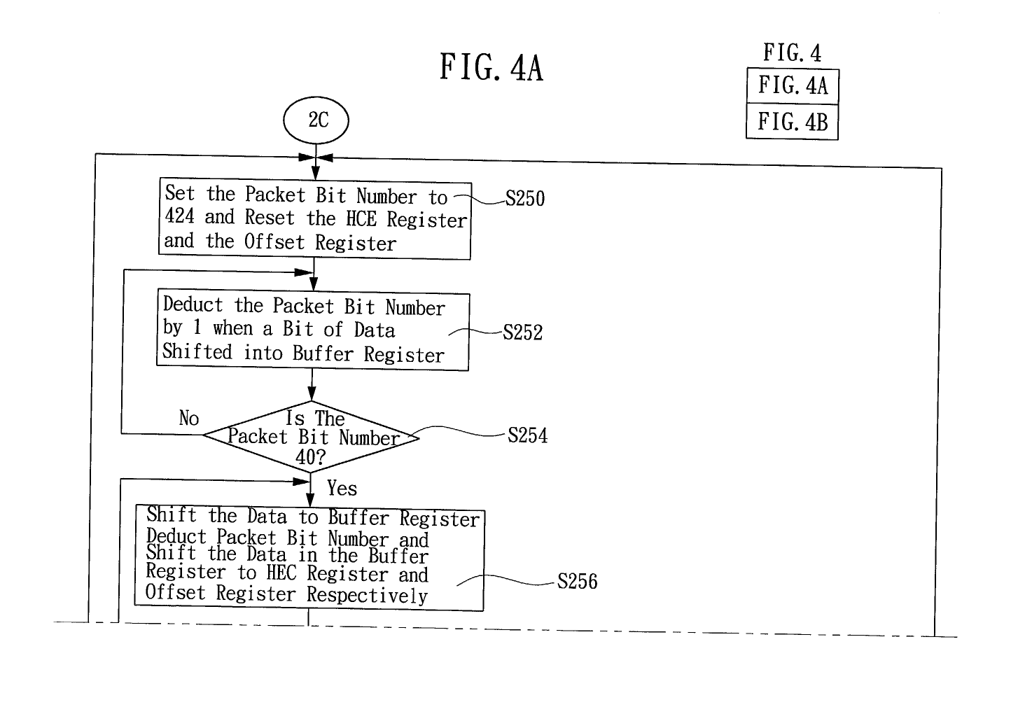

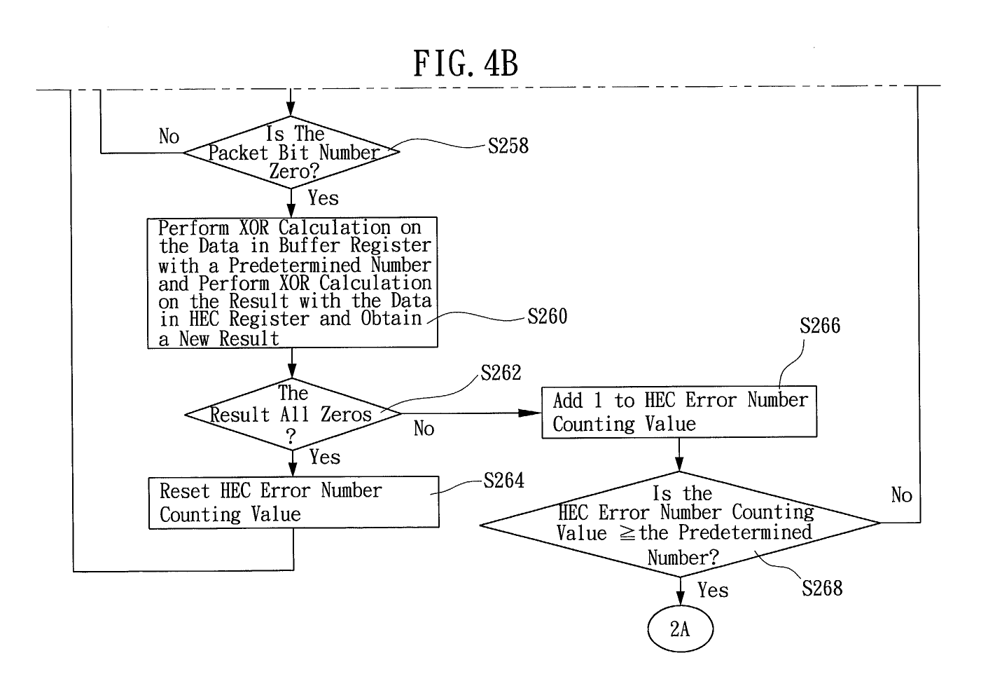

Please refer to FIG. 4A and FIG. 4B together, the step S250 to step S262 in this FIG. 4A and FIG. 4B are the same as the step S220 to step S232 in FIG. 3A and FIG. 3B. The difference is that, when all the bits are zeros in step S262, the HEC error number counting value in step S264 will be reset and the process will proceed to step S250 to check the packet coming in next. Otherwise, when the bits are not all zeros in step S262, the HEC error number counting value will be added by one in step S266, and in step S268, the HEC error number counting value will be checked to find if it is reaching the predetermined number that the state need to be switched. If the number has been reached, the process will proceed to the step S204 in FIG. 2 and the state of the receiving end of ATM will be switched to HUNT, otherwise, the process will continue in step S250 to check next incoming packet.

Please refer to FIG. 5, The sequential feedback Header Error Correction (HEC) checking circuit 30 is comprising a buffer register 32, a offset register 40, a HEC register 42 and a few XOR logic circuit 34, 36 and 38. The HEC register 42 is comprising a few bit store device 422 to 436 and a few internal XOR logic circuits 440 to 446. In the HEC register, the bit store device 422 will receive the data output from the XOR logic circuit 34. The internal XOR logic circuit 440 will receive the data output from the bit store device 422, the XOR logic circuit 34 and the offset register 40 and perform the XOR calculation. The bit store device 424 will receive the data output from the internal XOR logic circuit 440. The internal XOR logic circuit 442 will receive the data output from the bit store device 424 and the XOR logic circuit 34 and perform the XOR calculation. The bit store device 426 will receive the data output from the internal XOR logic circuit 442. The bit store device 428 will receive the data output from the bit store device 426. The bit store device 430 will receive the data output from the bit store device 428. The internal XOR logic circuit 444 will receive the data output from the bit store device 430 and the offset register 40 and perform the XOR calculation. The bit store device 432 will receive the data output from the internal XOR logic circuit 444. The internal XOR logic circuit 446 will receive the data output from the bit store device 432 and the offset register 40 and perform XOR calculation. The bit store device 434 will receive the data output from the internal XOR logic circuit 446. The bit store device 436 will receive the data output from the bit store device 434 and output the data to the XOR logic circuit 34.

Outside the HEC register 42, the XOR logic circuit 36 will XOR the data store in the buffer register 32 with the binary data 01010101 and come out with a first result. The first result will be XORed with the data that received thru the signal transfer channel 46 and stored in the HEC register 42 by the XOR logic circuit 38 and come out with a second result, the second result will be output to a control circuit 48. The control circuit 48 controls the change of state in the receiving end of ATM according to the second result.

More over, in this embodiment, an output switch 50 is connected to the output end of the buffer register 32. The output switch 50 is used to control the data transferring from the buffer register 32 to the XOR logic circuit 34, offset register 40 or the HEC register 42. And, the timing and the method of controlling the output switch 50 are illustrated in the preferred embodiment in FIG. 2, 3A, 3B, 4A and 4B.

As a conclusion, the present invention utilizes the hardware circuit to allocate the cell boundary in ATM communication instead of the method used in prior art that repeating calculations many times to allocate the cell boundary, as a result, which extremely saves time and improves the network efficiency.

While the present invention has been shown and described with reference to a preferred embodiment thereof, and in terms of the illustrative drawings, it should be not considered as limited thereby. Various possible modification, omission, and alterations could be conceived of by one skilled in the art to the form and the content of any particular embodiment, without departing from the scope and the spirit of the present invention.

What is claimed is:

1. A sequential feedback Header Error Correction (HEC) checking method for Asynchronous Transfer Mode (ATM), which is suitable for Asynchronous Transfer Mode (ATM) communication protocol and is comprising:
when ATM is in the state of HUNT, the following steps will be processed:
(a) setting the contents of an offset register and a HEC register to be zero when the ATM communication begin;
(b) shifting the data in a packet to a buffer register sequentially;
(c) executing XOR calculation on the data in said buffer register with a binary number 01010101 and coming out with a first result, and then shifting the data in said buffer register bit by bit to said HEC register and said offset register;
(d) executing XOR calculation on said first result with the data in said HEC register and coming out with a second result;
(e) changing the content of the logic circuit that storing the result of HEC checking if the bits in said second result are all zeros;
(f) setting the content of said offset register and said HEC register to be zero when a packet bit number is a default value of begin;
(g) shifting the data in said packet to said buffer register and changing the number of said packet bit number every time a bit shifted in;
(h) shifting the data from said buffer register bit by bit to said HEC register and said offset register;
(i) when said packet bit number is a default value of close, executing XOR calculation on the data in said buffer register with a binary number 01010101 and coming out with a third result;
(j) executing XOR calculation on said third result with the data in said HEC register and coming out with a fourth result;
(k) changing the content of the logic circuit that storing the result of HEC checking based on said fourth result.

2. The sequential feedback Header Error Correction (HEC) checking method for Asynchronous Transfer Mode (ATM) of claim 1, within, when ATM is in the state of HUNT, changing the content of a logic circuit that storing the number of HEC checking is comprising:
changing the state of ATM to PRESYNC; and
setting said packet bit number to 424.

3. The sequential feedback Header Error Correction (HEC) checking method for Asynchronous Transfer Mode (ATM) of claim 1, within, when ATM is in the state of PRESYNC, said default value of begin is set to 40, said default value of close is set to 0.

4. The sequential feedback Header Error Correction (HEC) checking method for Asynchronous Transfer Mode (ATM) of claim 3, within, when ATM is in the state of PRESYNC, changing the content of a logic circuit that storing the number of HEC checking is comprising:
when the bits of said fourth result are not all zeros, changing the state of ATM to HUNT, repeating the steps (b) to (e); and
when the bits of said fourth result are all zeros, changing the value of a correct checking parameter, when said correct checking parameter is equal to a certain value for changing state, changing the state of ATM to SYNC, when said correct checking parameter is not equal to a certain value for changing state, repeating the steps (f) to (k).

5. The sequential feedback Header Error Correction (HEC) checking method for Asynchronous Transfer Mode (ATM) of claim 1, within, when ATM is in the state of SYNC, said default value of begin is set to 40, said default value of close is set to 0.

6. The sequential feedback Header Error Correction (HEC) checking method for Asynchronous Transfer Mode (ATM) of claim 5, within, when ATM is in the state of PRESYNC, changing the content of a logic circuit that storing the number of HEC checking is comprising:
when the bits of said fourth result are not all zeros and the counting number of HEC errors is not equal to a default value, changing said counting number of HEC errors and repeating the steps (f) to (k);
when the bits of said fourth result are not all zeros and said counting number of HEC errors is equal to said default value, changing the state of ATM to HUNT and repeating the steps (b) to (e);
when the bits of said fourth result are all zeros, reset said counting number of HEC errors and repeating the steps (f) to (k);

7. The sequential feedback Header Error Correction (HEC) checking method for Asynchronous Transfer Mode (ATM) of claim 1, further, when changing the content of a logic circuit that storing the number of HEC checking, resetting the value that stored in said offset register to zero.

8. The sequential feedback Header Error Correction (HEC) checking circuit for Asynchronous Transfer Mode (ATM), which is suitable for Asynchronous Transfer Mode (ATM) communication protocol and is comprising:
a buffer register;
a offset register, connecting to the output of said buffer register and outputting sequentially the bit that said buffer register input;
a first XOR logic circuit, one end thereof connecting to the output of said buffer register with said offset register;
a HEC register, which receiving the data outputting from said first XOR logic circuit;
a second XOR logic circuit, which executing XOR calculation on the data stored in said buffer register and a binary data 01010101 and outputting a first result;
a third XOR logic circuit, which executing XOR calculation on the data stored in said HEC register with said first result and outputting a second result; and
a control circuit, which receiving the data outputting from said third XOR logic circuit.

9. The sequential feedback Header Error Correction (HEC) checking circuit for Asynchronous Transfer Mode (ATM of claim 8, wherein, said HEC register comprises:
a first bit store device, which receiving the data outputting from said first XOR logic circuit;
a first internal XOR logic circuit, which receiving the data outputting from said first bit store device, said first XOR logic circuit and said offset register;
a second bit store device, which receiving the data outputting from said first internal XOR logic circuit;
a second internal XOR logic circuit, which receiving the data outputting from said second bit store device and said first XOR logic circuit;
a third bit store device, which receiving the data outputting from said second internal XOR logic circuit;
a fourth bit store device, which receiving the data outputting from said third bit store device;
a fifth bit store device, which receiving the data outputting from said fourth bit store device;
a third internal XOR logic circuit, which receiving the data outputting from said fifth bit store device and said offset register;
a sixth bit store device, which receiving the data outputting from said third internal XOR logic circuit;
a fourth internal XOR logic circuit, which receiving the data outputting from said sixth bit store device and said offset register;
a seventh bit store device, which receiving the data outputting from said fourth internal XOR logic circuit; and
a eighth bit store device, which receiving the data outputting from said seventh bit store device and outputting data to said first XOR logic circuit.

10. The sequential feedback Header Error Correction (HEC) checking circuit for Asynchronous Transfer Mode (ATM) of claim 8, which further comprising:
a output switch, which connecting to the output of said buffer register and controlling whether output the data in said buffer register based on a controlling condition.

11. A synchronous checking method for Asynchronous Transfer Mode (ATM), which is suitable for Asynchronous Transfer Mode (ATM) communication protocol and is comprising:
(a) setting the contents of an offset register and a HEC register to be zero when the ATM communication begin;
(b) shifting the data in a packet to a buffer register sequentially;
(c) executing XOR calculation on the data in said buffer register with a binary number 01010101 and coming out with a first result, and then shifting the data in said buffer register bit by bit to said HEC register and said offset register; and
(d) executing XOR calculation on said first result with the data in said HEC register and coming out with a second result.
